(19) United States
(12) Patent Application Publication
(10) Pub. No.: US 2009/0204819 A1
(43) Pub. Date: Aug. 13, 2009

(54) ADVERTISEMENT-BASED HUMAN INTERACTIVE PROOF

(75) Inventor: Christopher Parker, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/027,276

(22) Filed: Feb. 7, 2008

(51) Int. Cl. H04K 1/00; H04L 9/00; G06F 17/00; G06F 3/00

(52) U.S. Cl. 713/182

(57) ABSTRACT

An arrangement for providing advertisement-based (“ad-based”) HIPs (human interactive proofs) is realized by using an advertisement as the basis of a HIP challenge that is readily solved by a user but is difficult for a computer-based application to solve. Users are accustomed to advertisements and can generally understand the content or message being delivered by them. But the typically complex mixture of graphics, colors, logos, texture, transparency, text, and other elements that may be utilized in a graphical advertisement provides the basis for an ad-based HIP challenge that is difficult to solve by a computer. In another illustrative example, audio comprising a slogan, musical jingle or ditty, spoken words, or other sounds (or combinations thereof) is used to convey an advertising message, while also providing the basis for an audio ad-based HIP.

### BACKGROUND

On-line interfaces are commonly used to provide users with a convenient means through which to order products such as tickets, access personal account information, open new e-mail accounts, or to access other services. These on-line systems are not only convenient to vendors as well as to their customers, but they also reduce overall costs.

Unfortunately such systems can also provide a vulnerability through which hackers can obtain access to personal or other restricted data, disrupt services, and distribute worms or spam. This is commonly done through the use of automated scripts or bots. For example, automated scripts or other computer applications can be developed to create thousands of new e-mail accounts. These accounts can then be used to send out worms or SPAM. These messages not only reflect poorly on the vendor, but at the same time they consume the vendor's resources, and possibly degrade the quality of services that are provided.

Automated scripts may also be developed to launch denial of service attacks against an on-line service, such as ticket sales. In this scenario, a malicious script could open hundreds of on-line sessions under the guise of legitimate ticket purchases, thus tying up the system so that real human customers are unable to access the service.

A common solution to this problem is through utilization of a Human Interactive Proof (“HIP”). HIPs are challenges designed to be readily solved by humans, so that they are not discouraged from using a service. At the same time, the HIP must be difficult enough to make the cost of developing or processing an automated script to break it uneconomical. Using a HIP challenge confirms that a person (i.e., a human user) is trying to access an on-line service or feature. This may help prevent automated scripts or programs from misusing such service or feature.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

An arrangement for providing advertisement-based (“ad-based”) HIPs is realized by using an advertisement as the basis of a HIP challenge that is readily solved by a user but is difficult for a computer-based application, script or other automated methodology to solve. Users are accustomed to advertisements and can generally easily and quickly understand the content or message being delivered by them. But the typically complex mixture of graphics, colors, logos, texture, transparency, text, and other elements that may be utilized in a graphical advertisement to make it interesting or exciting to the user, or to give it visual impact, for example, provides the basis for an illustrative graphical ad-based HIP challenge that is difficult to solve by a computer. In another illustrative example, audio comprising a slogan, musical jingle or ditty, spoken words, or other sounds (or combinations thereof) is used to convey an advertising message, while also providing the basis for an audio ad-based HIP.

Utilization of graphical ad-based HIP challenges enables advertisers to promote their interests in a way that actively engages a user to read and understand the content or message in the advertisement in order to solve the challenge. For example, the user will be asked to identify a product, service, company, slogan, or the like contained in the advertisement as the solution to the HIP challenge. Because the advertisements can be designed to be pleasing to the eye, and be readily visually and cognitively processed by the user, the opportunity to solve an ad-based HIP challenge may often be perceived as being less intrusive, or less difficult with which to interact, as compared with conventional HIP challenges (that are commonly character-based). Some users may even find ad-based HIP challenges enjoyable to solve. Audio ad-based HIP challenges can also be used as an assistive technology for sight-impaired users, or used as a supplement or alternative to graphical ad-based HIP challenges.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative computing environment in which a web client on a host machine displays a HIP challenge to a user;

FIG. 2A, 2B, 2C, and 2D show illustrative simplified examples of ad-based HIPs;

FIG. 3 is a first illustrative example in which a web client on a host machine displays an ad-based HIP challenge that asks the user to enter the name of a product displayed in a HIP;

FIG. 4 is a second illustrative example in which a web client on a host machine displays an ad-based HIP challenge that asks the user to enter the slogan displayed in a HIP;

FIG. 5 shows an illustrative deployment architecture that supports the utilization of ad-based HIP challenges; and

FIG. 6 is a flowchart of an illustrative method that may be implemented in the deployment architecture shown in FIG. 5.

Like reference numerals indicate like elements in the drawings. Elements in the drawings are not drawn to scale unless otherwise indicated.

### DETAILED DESCRIPTION

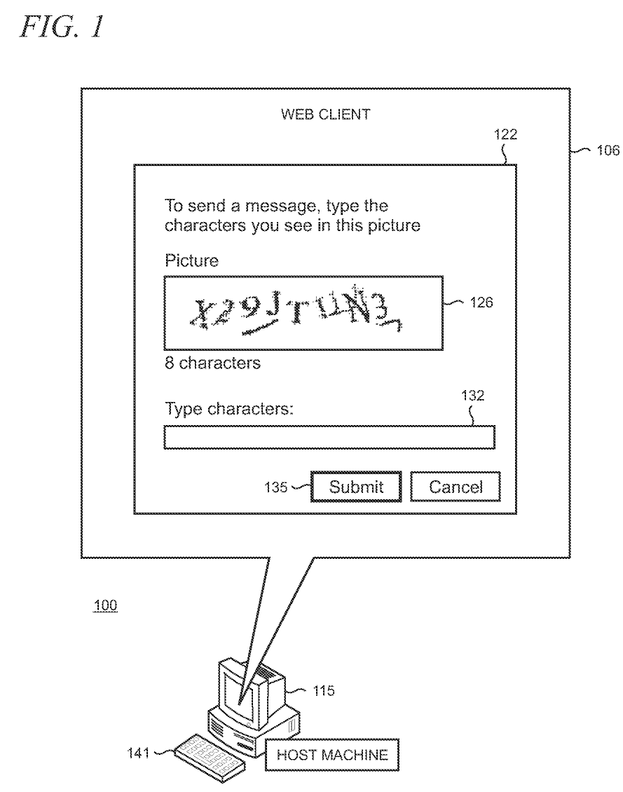

FIG. 1 shows an illustrative computing environment 100 in which a web client 106 running on a host machine 115 displays a HIP challenge 122 to a user. HIPs are also known as “CAPTCHAs” which is an acronym for “Completely Automated Public Turing tests to tell Computers and Humans Apart” coined by Carnegie Mellon University in 2000.

The web client 106 is arranged to enable the user working at the host machine 115 to browse and interact, using an on-line interface, with applications, content, services, and the like that are commonly provided by remote resource servers over networks such as the Internet. One example of a commercially available web client is the Microsoft Internet Explorer® web browser. In addition to protecting web-based content such as web pages, HIP challenges may also be utilized with Internet-enabled desktop software and applications. For example, messaging services, such as Windows Live™ Messenger, can use HIP challenges to help prevent spam messages from being sent by automated scripts, bots, or other processes.

While the host machine 115 is shown in this example as a desktop PC (personal computer), HIP challenges can be used on web clients that run on other types of devices including, for example, laptop PCs, game consoles, set-top boxes, handheld computers, portable media rendering devices, PDAs (personal digital assistants), mobile phones, and similar devices.

The HIP challenge 122 includes a HIP 126 that is configured, in typical existing computing environments, as a character-based HIP that the remote server provides as an image or picture for display by the web client 106. In this example, the HIP challenge 122 requires the user to recognize the eight characters in the HIP 126 and then type the recognized characters into a text entry box 132. The user clicks the submit button 135 on the HIP challenge 122 so that the user's solution to the challenge can be checked for correctness.

The user's typed characters must correctly match those shown in the HIP 126, and be entered in a matching sequence, before the remote server will grant the user access to a resource, or perform a requested action. For example, HIP challenges are commonly utilized to protect services that may be vulnerable to misuse, such as web-based e-mail services, blogs (i.e., weblogs), rating systems, and forums where spam e-mails and automated postings can be disruptive or cause harm. On-line resources such as libraries and search services also commonly utilize HIP challenges to prevent misuse.

In addition to accessing web-based resources, the computing environment 100 may alternatively be utilized in local networking scenarios. For example, HIP challenges may be used in an enterprise network to secure resources against misuse by automated processes running on remote machines, or even local machines in some cases.

As shown in FIG. 1, the HIP challenge 126 comprises an image containing random arcs and line (“clutter”) and jumbled or distorted-appearing characters that is intended to be only decipherable by a human. Character-based HIPs are in common use because characters were designed by humans for humans, and humans have been trained at recognizing characters since childhood. Each character has a corresponding key on the keyboard 141 coupled to the host machine 115 which facilitates convenient entry of the solution to the challenge, and the task of solving a HIP challenge is easily understood by users with minimal instructions.

Character-based HIPs can also be generated in an automated manner quickly by a process running on a remote server. However, while being capable of being quickly generated, a character-based HIP with eight characters still represents 100 billion potential solutions which helps prevent a HIP being solved through random guessing.

While current character-based HIPs can work very well in many applications, automated systems have become better at circumventing them through improved character recognition and image filtering and processing techniques. And users can sometimes find current HIP challenges to be a frustrating or unpleasant obstacle to a productive or enjoyable on-line experience. While users often appreciate and understand the necessity for HIP challenges to promote security, and they can be reasonably well tolerated, user resistance increases when the HIP challenge is difficult or awkward.

This is particularly the case when many present HIP challenges are becoming “harder” through the use of more distortion of the characters or employing other obfuscation techniques in the HIP image in an attempt to make the HIP more difficult to break by computer. Such techniques can include variation of parameters such as number of characters, number of valid characters, size, color, perturbation, density, arc characteristics, and warp, among others.

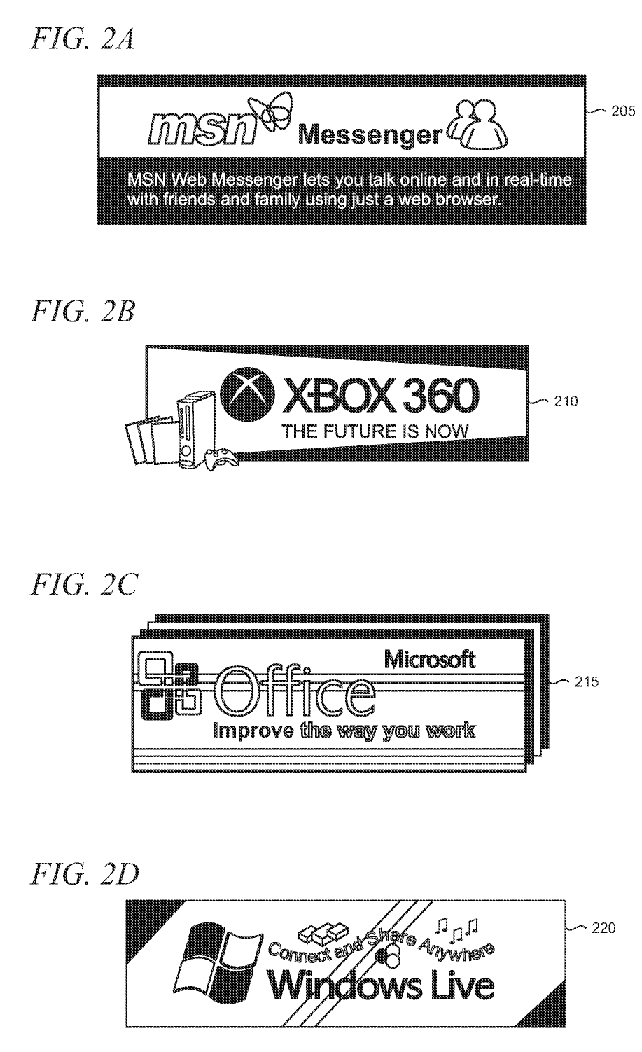

In contrast to the character-based HIP challenge shown in FIG. 1, FIGS. 2A, 2B, 2C, and 2D show illustrative simplified ad-based HIPs. It is noted that the ad-based HIPs shown in FIGS. 2A-2D are in simplified form by being drawn using black and white line art. However, it is anticipated that the ad-based HIPs will be rendered as full-color images in most actual implementations. As shown, the ad-based HIPs 205, 210, 215, and 220 utilize advertisements for various Microsoft products and services, including respectively, the MSN Messenger® instant messaging service, the Microsoft XBOX® video game system product, the Microsoft Office® productivity software suite, and the Microsoft Windows Live® service.

In addition to functioning as advertisements, the ad-based HIPs 205, 210, 215, and 220 are advantageously arranged to serve as the bases for HIP challenges that may be provided to users to solve as an alternative to conventional character-based HIP challenges. This aspect makes use of an ability to mix a variety of graphics, descriptive text, logos, colors, slogans, and other visual elements and effects into the image that makes up the ad-based HIP.

While the composition and mix of such elements will vary to meet the needs of a particular implementation such as the goals of the advertiser, the characteristics of the target user, the type of service or feature being protected by the HIP, etc., generally the HIP image will have sufficient complexity to present substantial difficulty for a computer-based application, script, or other automated methodology to parse the solution to the challenge out of the advertisement.

For example, the stylization and abstraction of the characters, and the manner in which they are related to, or embedded into, other graphical elements like colored backgrounds, line elements, borders, and the like, can make it very difficult for a computer to separate the characters from the remainder of the image in the correct order (a process called “segregation”) to be able to then attempt to identify the characters (a process called “recognition”). The issues associated with segregation and recognition in computer-based character recognition systems are well known.

By contrast, the use of an advertisement as the basis for a HIP challenge can be expected to be easily and quickly solved by a human user. This may result from a combination of general familiarity and comfort that users have in seeing and mentally processing advertisements, along with some tailoring of the ad-based HIP to allow it to function well as a HIP challenge. Such tailoring can take into account a number of factors including the size, font, positioning, and color, for example, of text elements in the ad-based HIP with respect to other graphical elements in the HIP image.

Typically, consideration will be given to maintaining the advertising benefit of the ad-based HIP challenge while increasing the difficulty of segregating characters for computer-based processing of the HIP image by using selectively utilizing background textures, foreground and background grids and lines, and variable color schemes. In addition, selection of font size, font style (italics, bold etc.), font type (serif, non-serif, monospace etc.), use of standard versus non-standard typefaces, degree of stylization, etc., will typically all play a role how a user perceives and responds to the advertisements. But these same factors will also drive the difficulty of computer recognition of characters if they are successfully segregated.

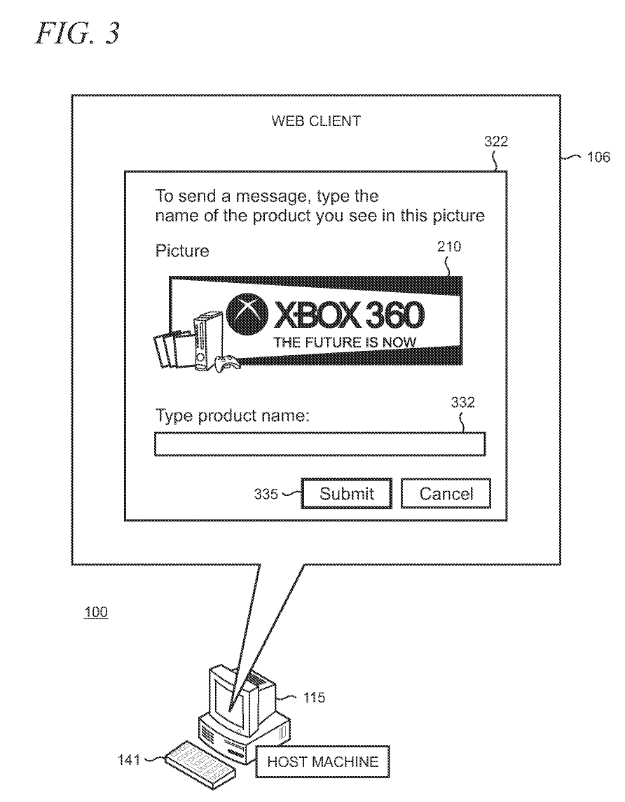

An ad-based HIP challenge may be displayed on a host machine 115 in the computing environment 100, and a user may interact with it in a similar manner as a conventional HIP challenge for example, when the user seeks to access a web page on the Internet, or uses an Internet-enabled application that is running locally. FIG. 3 is a first illustrative example in which the web client 106 on the host machine 115 displays an ad-based HIP challenge 322. The HIP challenge 322 asks the user to identify the name of a product displayed in the HIP 210. In this case, the solution is “XBOX 360” which the user must type into the text entry box 332 and submit via button 335 in order to successfully pass the challenge and gain access to a desired feature or service.

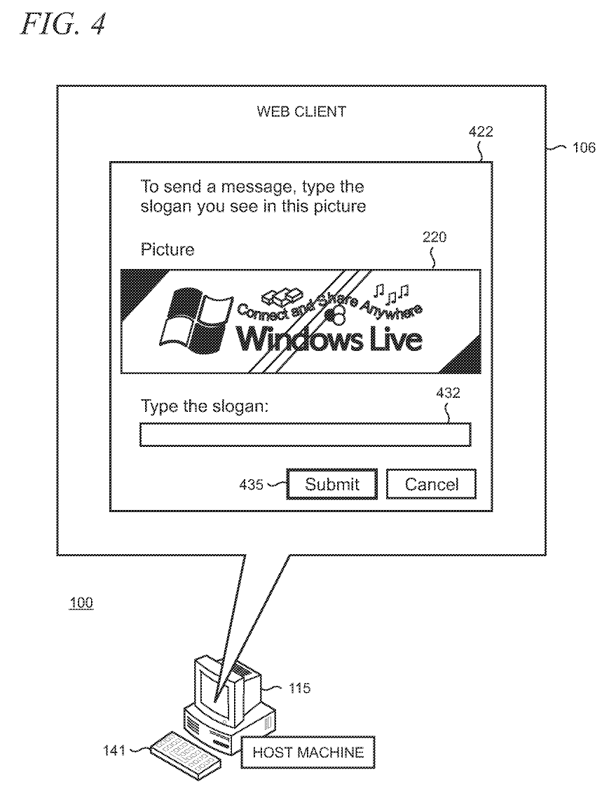

FIG. 4 shows a second example in which an ad-based HIP challenge 422 requests that the user identify the slogan displayed in the HIP 220. The user must enter the correct solution, which here is “Connect and Share Anywhere,” into the text entry box 432 and click the submit button 435 to successfully pass the challenge.

Other types of challenges may also be used with an ad-based HIP. For example, a user may be asked to identify the name of a service, feature, company, personality, object, descriptive text or characters, and so forth that is part of the advertisement. Some ad-based HIPs may also forgo the use of text altogether, particularly in the case where well known non-text-based logos or other symbols are utilized in the advertisement.

Because the advertisements can be vibrant, colorful, and informative, the ad-based HIP challenges can be designed to be more engaging and interesting for users to solve. Compared to conventional character-based HIPs which use a similar looking HIP where only the characters to be identified differ from challenge to challenge, the present ad-based HIP challenges can vary considerably in look and feel and have no real limits to the creative expression that may be utilized when designing them. As a result, the ad-based HIP challenges can be purposefully designed to remain fresh, or even entertaining and fun to solve for some users.

As an alternative or supplement to graphical ad-based HIPs, the ad-based HIP challenge may be audio-based by being implemented as an audio recording, file, or clip that is played on the user's computer or other device, typically for example, as an assistive technology to enable sight-impaired users to access websites, or use Internet-enabled or other locally-running applications. The audio may comprise, for example, a slogan, musical jiggle or ditty, spoken words, or other sounds (or combinations thereof) that are used to convey an advertising message while also providing the basis for an ad-based HIP.

In this example, a user would be prompted, for example, by a pre-recorded or synthesized voice (or by using text as with a graphical HIP), to identify and type in the name of a service, feature, or company from a short audio recording that is then played. For example, an audio ad-based HIP could start with the sounds of revving engines and screeching tires that are played over a fast-tempo rock music track before a voiceover next says “Get ready for high-flying stunt driving in Xbox Live Arcade due in stores in November, and only for the Xbox 360.” The user will type “Xbox” to successfully pass the challenge when prompted to identify the product in the advertisement. The sounds effects and music can help obscure the voice and reduce the ability for a computer to recognize the challenge answer. As a result, the audio ad-based HIP can generally be expected to be equally robust as conventional audio HIPs where users typically listen to obscured or garbled letters or numbers and then type them into their computers.

FIGS. 3 and 4 and the accompanying text highlight another significant advantage provided by the present arrangement for ad-based HIP challenges. In addition to providing a HIP that is easy for a user to solve while being hard for a computer to break, the ad-based HIPs function as an effective way for advertisers to deliver their message to a captive audience. Unlike so much web-based advertising that accompanies popular web portals such as search and news sites that users can easily ignore, here the user must actively engage in reading and understanding the content in the advertisement in the HIP challenge in order to identify the solution to the challenge.

This feature may be used to enable the advertiser to compose the advertisement and pick the HIP challenge solution to deliver a specific message to a known audience. For example, users posting comments to a blogging site dealing with parenting and child rearing could be presented with targeted advertising for child care products in a HIP challenge that is used to protect the blog. The solution to the ad-based HIP challenge might be the name of a new product that the advertiser is introducing into the marketplace.

It is emphasized, however, that these advantages may also be applicable to general advertising scenarios where the users coming to a site are more diverse in their profile. In this case, ad-based HIPs can be selected and utilized on an arbitrary or random basis, for example.

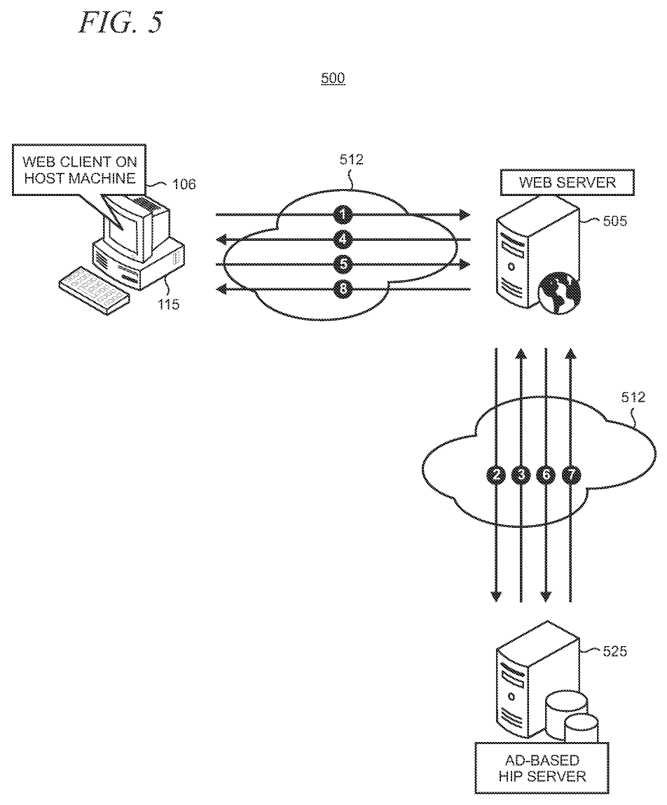

FIG. 5 shows an illustrative deployment architecture 500 that supports the utilization of ad-based HIP challenges. In this example, a web client 106 on a host machine 115 is in operative communication with a remote web server 505 over a network 512, such as the Internet or a private network. An ad-based HIP server 525 is in operative communication with the remote web server 505 over network 512. In alternative implementations, the ad-based HIP server 525 may be co-located with the remote web server 505 and communicate over, for example, a local area network.

The remote web server 505 hosts content, features, data, or services to which a user of the host machine 115 wishes to access and interact, and for which the web service provider would like to protect via ad-based HIP challenges. For example, HIP challenges are commonly utilized in web-based e-mail and messaging services.

The ad-based HIP server 525 is arranged to provide ad-based HIP challenges to the web server 505. The ad-based HIP server 525 will typically generate HIP challenges according to criteria, policies, or usage or business rules that are determined in advance and generally in accordance with one or more business agreements between the advertisers, ad-based HIP service provider, and web service provider. For example, the criteria, policies, usage or business rules might dictate that an ad-based HIP featuring a particular advertiser will be utilized with certain frequency and/or period of repetition, run on certain days or times, etc., or be provided in response to specific user actions or profiles. Using the blog example above, application of business rules to the ad-based HIP server 525 would enable an ad-based HIP featuring a diaper product from an advertiser to be used as the basis of the HIP challenge presented to the blog user.

In one illustrative business model, for example, the ad-based HIP service is monetized through collecting fees from the advertisers when their advertisements are used in a given ad-based HIP, and the user successfully completes the challenge by typing in and submitting the correct solution. In this regard, the monetization methodology is similar to other web-based advertising methods where revenue is generated on a “cost-per-click” or “cost-per-action” basis.

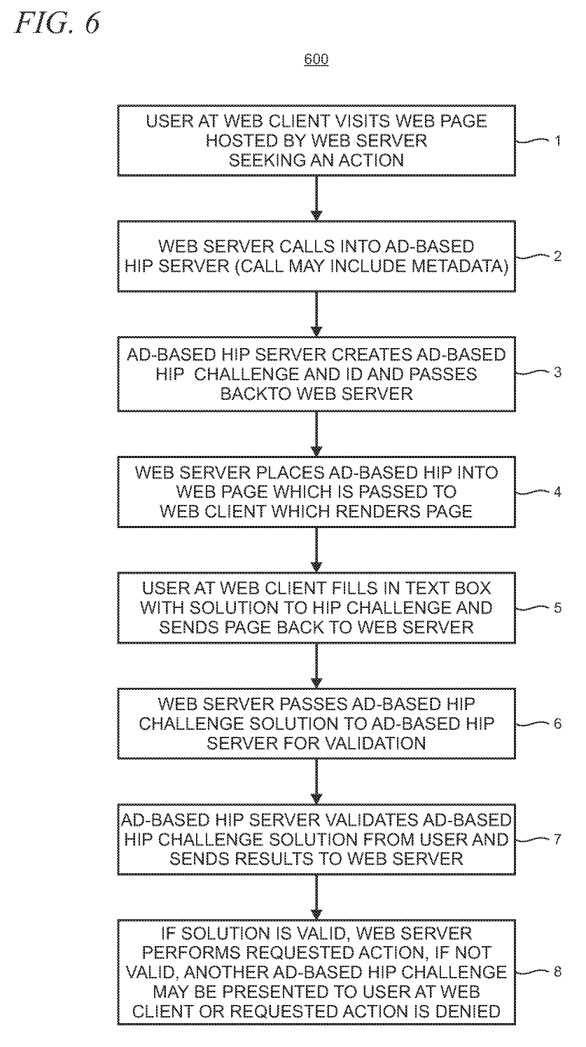

FIG. 6 is a flowchart 600 of an illustrative method that highlights details of the operations and interactions between the web client 106, web server 505, and ad-based HIP server 525 in the deployment architecture 500 shown in FIG. 5. The numbered text boxes in the flowchart 600 match up with corresponding numerals in FIG. 5 which indicate the communication flow between the components in the architecture.

At (1), the user at the web client 106 visits a web page hosted by the web server 505. The user typically is seeking some action be performed through the web server such as allowing the user to compose and send an e-mail or message using a web-based service. Alternatively, the user may be using a messaging service that is implemented using a locally-running instance of an Internet-enabled application. In both examples, the sought after action will not be performed until the user successfully completes an ad-based HIP challenge.

At (2), the web server 505 calls into the ad-based HIP server 525 with a request for an ad-based HIP challenge. In some implementations, the call from the web server 505 may include additional information such as metadata that identifies the web service for which the ad-based HIP challenge is to be applied, or provides a user profile or other information that may be used for targeted advertising, for example.

At (3), the ad-based HIP server 525 generates the ad-based HIP challenge and also, typically, a unique ad-based HIP challenge identification (“ID”) that may be used for revenue tracking or other purposes. As noted above, the ad-based HIP challenge may be generated according to pre-defined criteria, policies, or rules. The ad-based HIP challenge and ID are returned to the web server 505.

In an alternative implementation, it may be desirable for configure the ad-based HIP server 525 to generate just the ad-based HIP portion (e.g., one of the ad-based HIPs 205, 210, 215, and 220 in FIG. 2) and not the entire ad-based HIP challenge (which includes the rest of the user interface (“UI”) elements such as the instructions “To send a message, type the name of the product you see in this picture” as shown in FIG. 2, the text entry box, submit and cancel buttons etc.). Instead these UI elements may be generated by the web server 505. In this case, metadata that describes the context for the ad-based HIP (for example whether the challenge solution is a product name or a service name) can be provided by the ad-based HIP server 525. Such metadata would allow the web server 505 to compose the ad-based HIP challenge that is appropriate to a given ad-based HIP.

At (4), the web server 505 places the ad-based HIP challenge received from the ad-based HIP server 525 into a web page that is passed to the web client 106. This is typically accomplished by encoding the ad-based HIP challenge into the HTML (HyperText Markup Language) code that makes up the page. The web client 106 renders the page so that the user may be presented with the ad-based HIP challenge.

At (5), the user attempts to solve the ad-based HIP challenge and enters the solution into the text box (e.g., text boxes 332 and 432 in FIGS. 3 and 4, respectively). The web client 106 then sends the page back to the web server 505.

At (6), the web server 505 passes the ad-based HIP challenge solution from the user to the ad-based HIP server 525 for validation (i.e., determination as to whether the user's solution is correct or incorrect). In an alternative implementation, the web server 505 may perform the validation itself. In this case, the ad-based HIP server 525 will be configured to provide both the ad-based HIP challenge, as described at (3) above, and the answer to the challenge that the web server 505 will use to validate the user's solution.

At (7), the ad-based HIP server 525 validates the user's ad-based HIP challenge solution and sends the results of the validation back to the web server 505. In the alternative implementation where the web server 505 is provided with the answer to the HIP challenge and performs the validation step locally, this step (7) is not performed at the ad-based HIP server 525.

At (8), if the user's ad-based HIP challenge solution is valid (i.e., the user correctly solves the challenge), then the web server 505 performs the action desired by the user, for example, enabling the creation and sending of the web-based e-mail or message. If the user's solution is not valid, then the method described at steps (3) through (7) is repeated and the user is presented with another ad-based HIP challenge to solve.

In some implementations, the user may be given only a limited number of tries to solve an ad-based HIP challenge before the requested action is denied and the connection to the web client 106 shut down, since multiple unsuccessful attempts at solving an ad-based HIP challenge may indicate a host machine is running an automated script with malicious or inappropriate intent. The number of attempts allowed, and whether or not connections from unsuccessful clients are terminated will typically be specified by web service security policies which can vary between implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for protecting an on-line resource using a HIP challenge, the method comprising the steps of:
receiving a request to access the on-line resource from a remote client;
receiving an ad-based HIP, the ad-based HIP comprising an advertising component that is arranged to deliver advertising content to the user, and a HIP solution component, the advertising component and HIP solution component being integrated into a HIP image; and
encoding the HIP image into a page that when rendered on the remote client provides an ad-based HIP challenge; and
serving the page to the remote client.

2. The method of claim 1 including a step of requesting that the ad-based HIP be generated in response to the received request.

3. The method of claim 2 including a step of receiving the user's solution to the ad-based HIP challenge from the remote client, the user's solution comprising an attempt by the user to identify an object contained in the HIP solution component.

4. The method of claim 3 in which the object is one of company name, slogan, product name, service name, text, feature, alphanumeric character, or personality.

5. The method of claim 4 including a step of sending the user's solution for validation.

6. The method of claim 5 including a step of receiving a result of the validation.

7. The method of claim 6 including a step of granting the request to the on-line resource if the validation result indicates that the user's solution is correct.

8. The method of claim 7 including repeating the steps of receiving the ad-based HIP, encoding the HIP image, and serving the page to the remote client if the validation result indicates that the user's solution is incorrect.

9. A method for implementing a HIP challenge, the method comprising the steps of:
receiving a request to generate an ad-based HIP from an on-line service, the on-line service being configured to protect an on-line resource using an ad-based HIP challenge;
generating the ad-based HIP responsively to the request, the ad-based HIP comprising content that functions to deliver both advertising and a HIP that is renderable as an image in the ad-based HIP challenge by a web client;
validating a user's solution to determine if the user's solution correctly solves the ad-based HIP challenge; and
providing the results of the validating to enable access to the on-line resource according to the results.

10. The method of claim 9 including a step of providing metadata associated with the ad-based HIP, the metadata providing information that is usable to generate the ad-based HIP challenge that is configured with context that matches the advertising.

11. The method of claim 10 including a step of receiving metadata that is indicative of a user-profile or service-profile so that the ad-based HIP may be targeted to the user-profile or service-profile.

12. The method of claim 9 including a step of generating the ad-based HIP challenge.

13. The method of claim 9 in which the generating includes a further step of tailoring the advertising design to increase a degree of difficulty in segregating characters in the advertising when using automated character recognition methods.

14. A method for providing an ad-based HIP challenge in response to a request from a client, the method comprising the steps of:
providing an ad-based HIP for inclusion in the ad-based HIP challenge, the ad-based HIP challenge being configured to solicit the input of a solution to the ad-based HIP challenge, the solution being used for validating that the request is initiated from a human user, the ad-based HIP challenge being further configured to include advertising content that provides an image or audio-based rendering of the solution; and
receiving a solution to the ad-based HIP challenge, the received solution being generated at the client.

15. The method of claim 14 including a step of providing a second ad-based HIP for inclusion in the ad-based HIP challenge if the solution is determined to be incorrect.

16. The method of claim 14 including a step of terminating a connection with the client when the request is determined to be initiated from an automated process that is running on the client, the automated process being one of automated script, application, bot, or computer-based methodology.

17. The method of claim 14 including a step of tracking instances of successfully solving the ad-based HIP challenge in conjunction with one of a cost-per-click or cost-per-action cost models.

18. The method of claim 14 including a step of applying one or more criteria, policies, usage rules or business rules when providing the ad-based HIP, the one or more criteria, policies, usage rules, or business rules representing terms in a service agreement with a web-based service provider, or representing terms in a service agreement with an advertiser.

19. The method of claim 14 in which the providing is performed to target a given ad-based HIPs according to a user-profile or service-profile.

20. The method of claim 14 in which a determination of the solution involves the advertising be examined or read by the user.
